(19) United States
(12) Patent Application Publication
(10) Pub. No.: US 2013/0017439 A1
(43) Pub. Date: Jan. 17, 2013

(54) NONAQUEOUS SECONDARY BATTERY

(71) Applicant: Kentaro Takahashi, Sumoto-shi (JP)

(72) Inventor: Kentaro Takahashi, Sumoto-shi (JP)

(73) Assignee: SANYO ELECTRIC CO., LTD., Osaka (JP)

(21) Appl. No.: 13/548,333

(22) Filed: Jul. 13, 2012

(30) Foreign Application Priority Data
Jul. 14, 2011 (JP) 2011-155657

(51) Int. Cl. H01M 10/0564; H01M 4/131; H01M 4/62

(52) U.S. Cl. 429/188

(57) ABSTRACT

A nonaqueous secondary battery contains di(2-propynyl) oxalate in a proportion of not less than 0.05% and not more than 3% by mass relative to the total mass of the nonaqueous electrolyte, and causing the positive electrode mixture layer to contain a silane coupling agent, or one or more coupling agents expressed by Formula (I) below, in a proportion of not less than 0.003% and not more than 3% by mass relative to the mass of the positive electrode active material:

M[CO(R1)-CH═CO(R2)]ₙ (I)

where M is one item selected from Al, Ti and Zr, each of R1 and R2 is an alkyl group or alkoxy group with 1 to 18 carbon atoms, and n is an integer from 1 to 4).

### TECHNICAL FIELD

The present invention relates to a nonaqueous secondary battery that contains a lithium complex oxide as the positive electrode active material. In more detail, the present invention relates to a nonaqueous secondary battery that, when containing a nonaqueous electrolyte containing di(2-propynyl) oxalate, has small increase in the film resistance of the positive electrode-electrolyte interface, good ionic conductivity, and good charge-discharge cycling characteristics at high temperature and room temperature.

### BACKGROUND ART

Nonaqueous secondary batteries, which have high energy density and high capacity and are typified by lithium ion secondary batteries, are nowadays widely used as drive power sources for cellular telephones, portable personal computers, portable music players and other portable electronic equipment, and further as power sources for hybrid electric vehicles (HEVs) and electric vehicles (EVs).

For the positive electrode active material in these nonaqueous secondary batteries, lithium-transition metal complex oxides, typified by LiMO₂ (where M is one or more of CO, Ni and Mn), which are able to reversibly absorb and desorb lithium ions, are used, more precisely, LiCoO₂, LiNiO₂, LiNi_{y}Co_{1-y}O₂ (y=0.01 to 0.99), LiMnO₂, LiMn₂O₄, LiCoₓMn_{y}Ni_{z}O₂ (x+y+z=1), LiFePO₄, or the like, either singly or mixed together.

Of these, use is often made of a lithium-cobalt complex oxide or a lithium complex oxide with dissimilar metal elements added because these yield much superior battery characteristics relative to the other items. However, cobalt is expensive and moreover exists in only small quantities. Therefore, in order to continue using lithium-cobalt complex oxide and lithium complex oxide with dissimilar metal elements added as the positive electrode active material in nonaqueous secondary batteries, it will be desirable that these batteries be given even higher performance.

On the other hand, a nonaqueous secondary battery is prone to degradation of its positive electrodes if it is stored in a high-temperature environment in the charged state. This is considered to be because when a nonaqueous secondary battery is so stored in the charged state, oxidative decomposition of the nonaqueous electrolyte on the positive electrode active material and elution of the transition metal ions of the positive electrode active material will occur, and moreover, a high-temperature environment will accelerate such decomposition and elution more than a normal-temperature environment will.

With regard to that, JP-A-2005-190754 sets forth a nonaqueous secondary battery that contains a nonaqueous electrolyte that contains vinylene carbonate (VC) and di(2-propynyl) oxalate (D2PO) in order to enhance the battery's long-term charge-discharge cycling characteristics at high temperature without lowering its initial capacity and to curb swelling of the battery at such times.

Also, JP-A-09-199112 sets forth a nonaqueous secondary battery in which an aluminum-based coupling agent is mixed into the positive electrode mixture in order to enhance the battery's cycling characteristics under high-voltage and charging/discharging conditions. Furthermore, JP-A-2002-319405 sets forth a nonaqueous secondary battery in which a silane coupling agent having an organic reaction group such as an epoxy group or amino group and a linking group such as a methoxy group or ethoxy group is dispersed into the positive electrode mixture in order to improve the wettability of the positive electrodes by the electrolyte at low temperature and produce good output characteristics at low temperature.

Also, JP-A-2007-242303 sets forth a nonaqueous secondary battery in which the positive electrode active material is treated with a silane coupling agent that has multiple linking groups, in order to enhance the cycling characteristics when an intermittent cycle is repeated. Furthermore, JP-A-2007-280830 sets forth a nonaqueous secondary battery in which a silane coupling agent is made to be present near the fracture surfaces of the positive electrode active material which occur during compression of the positive electrode mixture layers, in order to enhance the cycling characteristics.

With the invention disclosed in JP-A-2005-190754, a mixed film of VC and D2PO is formed as the solid electrolyte interface (SEI) film that arises on the surface of the carbon negative electrode. By this means, deterioration of the D2PO film is prevented and the VC film is curbed from dissolving during charge-discharge cycling at high temperature.

However, when the nonaqueous electrolyte contains D2PO, reaction products from the oxidative decomposition of the D2PO will build up on the positive electrode surfaces. Such film formed on the positive electrode surfaces will function so that direct contacting between the electrolyte or separators and the positive electrodes is avoided, and will raise the film resistance at the positive electrode-electrolyte interfaces. As a result, there are the issues that ion conduction at the positive electrode-electrolyte interfaces will be hindered and, with the high-temperature and especially the room-temperature charge-discharge cycling characteristics, the capacity retention rate will fall drastically.

Also, according to the inventions disclosed in JP-A-2002-319405, JP-A-2007-242303 and JP-A-2007-280830, one finds that it is suggested that by mixing a silane-based or aluminum-based coupling agent into the positive electrode mixture, enhancement of the cycling characteristics and enhancement of the output characteristics in a low-temperature environment can roughly speaking be achieved. Yet, even with these inventions disclosed in the above-mentioned three patents, enhancement of the high-temperature and room-temperature charge-discharge cycling characteristics cannot be said to be adequate.

Accordingly, the present inventors conducted many and various experiments to ameliorate the decline of the high-temperature and room-temperature charge-discharge cycling characteristics of nonaqueous secondary batteries when di(2-propynyl) oxalate is added to a nonaqueous electrolyte such as described above, and as a result arrived at the present invention upon discovering that such issue can be resolved by causing a silane-based or aluminum-based coupling agent to be contained in the positive electrode mixture in a particular amount.

### SUMMARY

An advantage of some aspects of the invention is to provide a nonaqueous secondary battery that contains a lithium complex oxide as the positive electrode active material, wherein the charge-discharge cycling characteristics at high temperature and room temperature are good.

According to an aspect of the invention, a nonaqueous secondary battery includes: a positive electrode plate on which is formed a positive electrode mixture layer that contains a lithium complex oxide as positive electrode active material; a negative electrode plate; a separator; and nonaqueous electrolyte. The nonaqueous electrolyte contains di(2-propynyl) oxalate (D2PO) in a proportion of not less than 0.05% and not more than 3% by mass relative to the total mass of the nonaqueous electrolyte, and the positive electrode mixture layer contains a silane coupling agent, or one or more coupling agents expressed by Formula (I) below (termed “specific coupling agent” below), in a proportion of not less than 0.003% and not more than 3% by mass relative to the mass of the positive electrode active material:

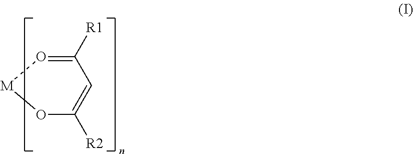

(where M is one item selected from Al, Ti and Zr, each of R1 and R2 is an alkyl group or alkoxy group with 1 to 18 carbon atoms, and n is an integer from 1 to 4).

With the nonaqueous electrolyte containing di(2-propynyl) oxalate (D2PO) in a proportion of not less than 0.05% and not more than 3% by mass relative to the total mass of the nonaqueous electrolyte, and the positive electrode mixture layer containing a specific coupling agent in a proportion of not less than 0.003% and not more than 3% by mass relative to the mass of the positive electrode active material, in the nonaqueous secondary battery of the invention, it is inferred that before the D2PO oxidatively decomposes on the surface of the positive electrode, the specific coupling agent will act at the interfaces between the positive electrode mixture layer surface and the electrolyte, and curb the lowering of ion conductivity at these interfaces during charge-discharge cycling. Thus, it can be considered that the ion conductivity at the interfaces between the positive electrode mixture layer surface and the electrolyte will be curbed from declining, and so the high-temperature and room-temperature charge-discharge cycling characteristics will be enhanced.

Note that if the D2PO content were under 0.05% by mass relative to the total mass of the nonaqueous electrolyte, stable SEI films could not be formed on the negative electrode. Also, if the D2PO content exceeded 3% by mass relative to the total mass of the nonaqueous electrolyte, reaction products from oxidative decomposition would build up on the positive electrode, raising the film resistance at the positive electrode mixture layer-electrolyte interfaces. The D2PO content is more preferably at a proportion of not less than 0.1% and not more than 0.5% by mass relative to the total mass of the nonaqueous electrolyte; if so, the high-temperature and room-temperature charge-discharge cycling characteristics are likely to be further enhanced.

Also, if the specific coupling agent were under 0.003% by mass relative to the mass of the positive electrode active material, it would be too little and the advantages of adding the specific coupling agent would not be obtained. If the specific coupling agent content exceeded 3% by mass relative to the mass of the positive electrode active material, the resistance of the positive electrodes would become large and so the initial capacity would fall. The specific coupling agent content is more preferably at a proportion of not less than 0.1% and not more than 0.5% by mass relative to the mass of the positive electrode active material; if so, the initial capacity is not likely to fall and the high-temperature and room-temperature charge-discharge cycling characteristics are likely to be further enhanced.

Also, it is preferable that the positive electrode active material in the nonaqueous secondary battery of the invention have average particle diameter 4.5 to 15.5 μm and specific surface area 0.13 to 0.80 m²/g. With the average particle diameter and specific surface area of the positive electrode active material being within these ranges, the high-temperature and room-temperature charge-discharge cycling characteristics will be further enhanced.

Furthermore, as the positive electrode active material in the nonaqueous secondary battery of the invention, it is preferable that use be made of a lithium complex oxide such as LiCoO₂, LiNiO₂, LiMn₂O₄, LiMnO₂, LiNi₁₋ₓMnₓO₂ (0<x<1), LiNi₁₋ₓCoₓO₂ (0<x<1) or LiNiₓMn_{y}Co_{z}O₂ (0<x, y, z<1; x+y+z=1), or of a phosphate compound having an olivine structure, such as LiFePO₄.

Also, the method for imparting a specific coupling agent content into the positive electrode mixture layer in the nonaqueous secondary battery of the invention may be either by directly spreading the agent over the positive electrode plate or by mixing the agent into the positive electrode mixture slurry. There is no particular restriction regarding the specific coupling agent, and examples thereof may include appropriate organic solvents in a diluted state, including ketones such as acetone and methylethyl ketone (MEK); ethers such as tetrahydrofuran (THF); alcohols such as ethanol and isopropanol; and N-methyl-2-pyrrolidone (NMP) and silicone oil.

Examples of negative electrode active materials that can be used in the nonaqueous secondary battery of the invention may include carbon materials such as graphite, non-graphitizable carbon and graphitizable carbon; titanium oxides such as LiTiO₂ or TiO₂; semimetallic elements such as silicon or tin; and Sn—Co alloy.

Examples of the nonaqueous solvent that can be used in the nonaqueous secondary battery of the invention may include cyclic carbonate esters such as ethylene carbonate (EC), propylene carbonate (PC) and butylene carbonate (BC); fluorinated cyclic carbonate esters; cyclic carboxylic esters such as γ-butyrolactone (BL) and γ-valerolactone (VL); chain carbonate esters such as dimethyl carbonate (DMC), ethylmethyl carbonate (EMC), diethyl carbonate (DEC), methylpropyl carbonate (MPC), and dibutyl carbonate (DNBC); chain carboxylic esters such as methyl pivalate, ethyl pivalate, methyl isobutyrate or methyl propionate; amide compounds such as N,N′-dimethyl formamide and N-methyl oxazolidinone; sulfur compounds such as sulfolane; and ambient-temperature molten salts such as tetrafluoroboric acid 1-ethyl-3-methyl imidazolium. It will be preferable to use two or more of these items mixed together. Particularly preferable among these will be EC, PC, chain carbonate ester, and tertiary carboxylic ester.

Examples of the separator to be used in the nonaqueous secondary battery of the invention may include separators constituted of microporous film formed from a polyolefin material such as polypropylene or polyethylene. In order to assure shutdown responsiveness of the separators, one could mix in a plastic with low melting point, and to obtain heat resistance one could use a layer stack containing layers of high melting point plastic, or a plastic supported by inorganic particles.

Moreover, into the nonaqueous electrolyte used in the nonaqueous secondary battery of the invention, as a chemical compound for stabilizing the electrodes, the following may be added: vinylene carbonate (VC), vinylethyl carbonate (VEC), succinic anhydride (SUCAH), maleic anhydride (MAAH), glycolic acid anhydride, ethylene sulfite (ES), divinyl sulfone (VS), vinyl acetate (VA), vinyl pivalate (VP), catechol carbonate, biphenol (BP) or the like. Two or more of these compounds could be used suitably mixed together.

Examples of the electrolytic salt that is dissolved in the nonaqueous solvent used in the nonaqueous secondary battery of the invention may include the lithium salt that is ordinarily used as the electrolytic salt in nonaqueous secondary batteries. Examples of such lithium salt are LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀CL₁₀, Li₂B₁₂CL₁₂, and mixtures of these. Of these items, it is particularly preferable that LiPF6 (lithium hexafluorophosphate) be used. It is preferable that the dissolved volume of the electrolytic salt relative to the nonaqueous solvent be 0.5 to 2.0 mol/L.

Examples of the silane coupling agent used in the nonaqueous secondary battery of the invention may include an item that has at least one organic functional group and multiple linking groups inside its molecule. Any organic functional group that has a hydrocarbon backbone of one kind or another will be acceptable. Examples of such an organic functional group may include, for example, an alkyl group, a mercaptopropyle group, and a trifluoropropyl group. Also, the linking group can be, for example, a hydrolyzable alkoxy group.

Examples of the “M” in a coupling agent having the structure of Formula I above may include one item selected from among Al, Ti and Zr. Of these however, Al will be particularly preferable as M. With Al used as M, the agent can be synthesized at low cost, and moreover better results will be obtained than where Ti or Zr is used as M.

Also, the characteristic improvement advantages will be larger if either or both of R1 and R2 in a coupling agent having the structure of Formula I above is an alkoxyl group (ethoxy group, isopropoxy group, tert-butoxy group or the like group). Also, it is preferable that an alkoxyl group (isopropoxy group, tert-butoxy group or the like group) be linked to the M atom in Formula I above, so that the reactivity with respect to the positive electrode active material will be enhanced. Furthermore, it is preferable that up to two alkoxyl groups be linked to the M atom, which will heighten the hydrolysis resistance of the chemical compound.

Also, it is preferable that the specific coupling agent be one or more items selected from the group consisting of aluminum bis(ethylacetoacetate) monoacetylacetonate, aluminum ethylacetoacetate diisopropylate, aluminum tris(ethylacetoacetate), aluminum tris(acetylacetonate), titanium bis(ethylacetoacetate) diisopropoxide, titanium bis(ethylacetoacetate) bis(acetylacetonate), zirconium tetrakis(acetylacetonate), methyltrimethoxysilane, dimethylmethoxysilane, methyltriethoxysilane, hexyltrimethoxysilane and 3-acryloxypropyltrimethoxysilane. Of these, aluminum bis(ethylacetoacetate) monoacetylacetonate is particularly preferable.

### DESCRIPTION OF EXEMPLARY EMBODIMENTS

Preferred embodiments for carrying out the invention will now be described in detail using Examples and Comparative Examples. However, it should be understood that these embodiments set forth below are intended by way of examples for understanding the technical concepts of the invention, and not by way of limiting the invention to these particular nonaqueous secondary batteries. The invention can equally well be applied to produce many different variants without departing from the scope and spirit of the technical concepts set forth in the claims.

First of all will be described the specific methods for manufacturing a nonaqueous secondary battery, which are common to the various Examples and Comparative Examples.

Fabrication of Positive Electrode

One of the various positive electrode active materials was mixed with Amorphous Carbon HS-100 (commercial product name) serving as conducting agent and polyvinylidene fluoride (PVdF), in the proportion 95:2.5:2.5% by mass, to produce a positive electrode mixture, to which was added N-methyl-pyrrolidone (NMP) in a quantity equal to 50% of the mass of the positive electrode mixture, thus rendering it into a slurry. One of the various coupling agents was added in a particular quantity to the slurry thus obtained, and thoroughly stirred, then the slurry was spread over both surfaces of 12 μm-thick aluminum foil using the doctor blade method (spread quantity 440 g/m²). After that, the resulting item was dried by heating (70 to 140° C.) and pressure-formed to a bulk density of 3.66 g/cc (for LiMn₂O₄ and LiMn_{1/3}Ni_{1/3}Co_{1/3}O₂, 3.15 g/cc), then cut out into a particular size to obtain the positive electrode plate.

Fabrication of Negative Electrode

Artificial graphite (d=0.336 nm) was mixed with carboxymethyl cellulose (CMC) serving as thickener and styrenebutadiene rubber (SBR) serving as binder, in the proportion 97:2:1% by mass, then water was added to render the mixture into a slurry, which was spread over both surfaces of 8 μm-thick copper foil (spread quantity 210 g/m²). After that, the resulting item was dried and pressure-formed to a bulk density of 1.60 g/cc, then cut out into a particular size to obtain the negative electrode plate.

Fabrication of Battery Prior to Electrolyte Pouring

A wound electrode assembly was fabricated by welding tabs onto positive electrode plates and negative electrode plates cut out to a particular size, then winding them with separators that were 16 μm-thick microporous films of polyethylene interposed. The electrode assembly thus obtained was housed inside a cup-formed laminate outer shell, which was then heat-sealed, leaving open a pour mouth, to produce a battery awaiting electrolyte pouring.

Completion of Battery

A nonaqueous electrolyte was prepared by dissolving LiPF₆ serving as electrolytic salt into a nonaqueous solvent of EC, PC, EMC and methyl pivalate mixed in the proportion 25:5:10:60% by volume, so that the LiPF₆ concentration was 1 M. 19 ml of this nonaqueous electrolyte was poured in through the pour mouth, then vacuum impregnation treatment was carried out. Following that, the pour mouth was heat⁻sealed and charging-discharging was carried out, to complete the nonaqueous secondary battery of design capacity 3850 mAh (1 It=3850 mA).

Measurement of Battery Characteristics

The initial capacity and high-temperature and room-temperature cycling characteristics of the batteries of each Example and Comparative Example fabricated in the foregoing manner were determined in accordance with the measuring methods below.

Measurement of Initial Capacity

The battery of each Example and Comparative Example was charged with constant current of 0.5 It=1925 mA in a thermostatic chamber at 25° C. until the battery voltage reached 4.2V. When the battery voltage had reached 4.2V, the battery was further charged with constant voltage of 4.2V until the current became 1/20 It=193 mA. The charge capacity that was determined at this point was taken as the normal-temperature charge capacity. Following that, the battery was discharged with constant current of 0.5 It=1925 mA until the battery voltage became 2.75V. The discharge capacity that was determined at this point was taken as the initial capacity.

Measurement of 25° C. Cycling Characteristic

The battery of each Example and Comparative Example was charged with constant current of 1 It=3850 mA in a thermostatic chamber at 25° C. until the battery voltage reached 4.2V. When the battery voltage had reached 4.2V, the battery was further charged with constant voltage of 4.2V until the current became 1/20 It=193 mA. Following that, the battery was discharged with constant current of 1 It=3850 mA until the battery voltage became 2.75V. The discharge capacity that was determined at this point was taken as the discharge capacity after one cycle. The same charge-discharge cycle was repeated one thousand times, and the discharge capacity that was determined after the one thousandth cycle was taken as the discharge capacity after one thousand cycles. The following calculation equation was then used to derive the 25° C. cycling characteristic (%):

25° C. cycling characteristic (%)=(Discharge capacity after one thousand cycles/Discharge capacity after one cycle)×100

Measurement of 45° C. Cycling Characteristic

The 45° C. cycling characteristic was measured in the following manner. The battery of each Example and Comparative Example was charged with constant current of 1 It=3850 mA in a thermostatic chamber at 45° C. until the battery voltage reached 4.2V. When the battery voltage had reached 4.2V, the battery was further charged with constant voltage of 4.2V until the current became 1/20 It=193 mA. Following that, the battery was discharged with constant current of 1 It=3850 mA until the battery voltage became 2.75V. The discharge capacity that was determined at this point was taken as the discharge capacity after one cycle. The same charge-discharge cycle was repeated one thousand times, and the discharge capacity that was determined after the one thousandth cycle was taken as the discharge capacity after one thousand cycles. The following calculation equation was then used to derive the 45° C. cycling characteristic (%):

45° C. cycling characteristic (%)=(Discharge capacity after one thousand cycles/Discharge capacity after one cycle)×100

Examples 1 to 6 and Comparative Examples 1 to 11

As the positive electrode active material in the nonaqueous secondary batteries of Examples 1 to 6 and Comparative Examples 1 to 11, LiCoO₂ with average particle diameter 9.7 μm and specific surface area 0.38 m²/g was used. Note that below, the amount of di(2-propynyl) oxalate (D2PO) added refers to its proportion relative to the total mass of the nonaqueous electrolyte, and the amount of coupling agent added refers to its proportion relative to the mass of the positive electrode active material.

In Comparative Example 1, no D2PO was contained in the nonaqueous electrolyte and no coupling agent was added to the positive electrode mixture layers. In Comparative Examples 2 to 8, D2PO was added to the nonaqueous electrolyte in amounts varying from 0.03 to 2% by mass, and no coupling agent was added to the positive electrode mixture layers.

In Comparative Example 9, no D2PO was added to the nonaqueous electrolyte, and 0.2% by mass of aluminum bis(ethylacetoacetate) monoacetylacetonate as coupling agent was added to the positive electrode mixture layers. Furthermore, in Comparative Examples 10 and 11, 0.2% by mass of aluminum bis(ethylacetoacetate) monoacetylacetonate as coupling agent was added to the positive electrode mixture layers, and D2PO was added to the nonaqueous electrolyte in the amount of 0.03% by mass for Comparative Example 10 and 3% by mass for Comparative Example 11.

Furthermore, in Examples 1 to 6, 0.2% by mass of aluminum bis(ethylacetoacetate) monoacetylacetonate as coupling agent was added to the positive electrode mixture layers, and D2PO was added to the nonaqueous electrolyte in amounts varying from 0.03 to 2% by mass. The measurement results for Examples 1 to 6 and Comparative Examples 1 to 11 are gathered in Table 1.

TABLE 1

| | | Coupling agent | | | | |
|---|---|---|---|---|---|---|
| | Amount of | | Amount | | | |
| | di(2-propynyl) | | added | Initial | Cycling | |
| | oxalate added | | (% by | capacity | characteristics | |
| | (% by mass) | Name | mass) | (mAh) | 45° C. (%) | 25° C. (%) |
| Comparative | None | None | — | 3863 | 54 | 81 |
| Example 1 | | | | | | |
| Comparative | 0.03 | None | — | 3859 | 57 | 77 |
| Example 2 | | | | | | |
| Comparative | 0.05 | None | — | 3863 | 73 | 70 |
| Example 3 | | | | | | |
| Comparative | 0.1 | None | — | 3857 | 77 | 66 |
| Example 4 | | | | | | |
| Comparative | 0.2 | None | — | 3853 | 80 | 57 |
| Example 5 | | | | | | |
| Comparative | 0.5 | None | — | 3862 | 78 | 55 |
| Example 6 | | | | | | |
| Comparative | 1 | None | — | 3864 | 71 | 49 |
| Example 7 | | | | | | |
| Comparative | 2 | None | — | 3860 | 52 | 46 |
| Example 8 | | | | | | |
| Comparative | None | Aluminum | 0.2 | 3863 | 53 | 80 |
| Example 9 | | bis(ethylacetoacetate) | | | | |
| | | monoacetylacetonate | | | | |
| Comparative | 0.03 | Aluminum | 0.2 | 3858 | 54 | 80 |
| Example 10 | | bis(ethylacetoacetate) | | | | |
| | | monoacetylacetonate | | | | |
| Example 1 | 0.05 | Aluminum | 0.2 | 3856 | 77 | 81 |
| | | bis(ethylacetoacetate) | | | | |
| | | monoacetylacetonate | | | | |
| Example 2 | 0.1 | Aluminum | 0.2 | 3852 | 82 | 80 |
| | | bis(ethylacetoacetate) | | | | |
| | | monoacetylacetonate | | | | |
| Example 3 | 0.2 | Aluminum | 0.2 | 3864 | 84 | 82 |
| | | bis(ethylacetoacetate) | | | | |
| | | monoacetylacetonate | | | | |
| Example 4 | 0.5 | Aluminum | 0.2 | 3855 | 80 | 81 |
| | | bis(ethylacetoacetate) | | | | |
| | | monoacetylacetonate | | | | |
| Example 5 | 1 | Aluminum | 0.2 | 3860 | 74 | 79 |
| | | bis(ethylacetoacetate) | | | | |
| | | monoacetylacetonate | | | | |
| Example 6 | 2 | Aluminum | 0.2 | 3864 | 62 | 77 |
| | | bis(ethylacetoacetate) | | | | |
| | | monoacetylacetonate | | | | |
| Comparative | 3 | Aluminum | 0.2 | 3859 | 53 | 66 |
| Example 11 | | bis(ethylacetoacetate) | | | | |
| | | monoacetylacetonate | | | | |

Positive electrodes: LiCoO₂
Average particle diameter: 9.7 μm
Specific surface area: 0.38 m²/g

The following can be seen from the results set forth in Table 1. From the results for Comparative Examples 1 to 8, in which no coupling agent was added to the positive electrode mixture layers, it can be seen that the room-temperature cycling characteristics declined when D2PO was added to the nonaqueous electrolyte (Comparative Examples 2 to 8), as opposed to the case where no D2PO was added (Comparative Example 1).

Also, the results for Comparative Example 9, in which coupling agent was added to the positive electrode mixture layers but no D2PO was added to the nonaqueous electrolyte, are roughly equivalent to those for Comparative Example 1, in which neither coupling agent nor D2PO was added. From this it can be seen that when no D2PO is added, there will be no effects on the high-temperature and room-temperature cycling characteristics, whether coupling agent is added or not to the positive electrode mixture layers.

By contrast, if 0.2% by mass of aluminum bis(ethylacetoacetate) monoacetylacetonate as coupling agent is added to the positive electrode mixture layers and 0.03 to 2% by mass of D2PO is added to the nonaqueous electrolyte (Examples 1 to 6), then the room-temperature cycling characteristics will be roughly equivalent, or superior albeit only slightly, to those in Comparative Example 1, and moreover, the high-temperature cycling characteristics will be drastically superior to those in Comparative Examples 1 to 10.

Also, it can be seen from the results for Comparative Example 11 and Examples 1 to 6 that if 0.2% by mass of aluminum bis(ethylacetoacetate) monoacetylacetonate as coupling agent is added to the positive electrode mixture layers and the amount of D2PO that is added to the nonaqueous electrolyte does not exceed 2% by mass relative to the total mass of the nonaqueous electrolyte, then both the high-temperature and room-temperature cycling characteristics will decline.

Examples 7 to 24 and Comparative Examples 12 and 13

In the nonaqueous secondary batteries of Examples 7 to 24 and Comparative Examples 12 and 13, LiCoO₂ with average particle diameter 9.7 μm and specific surface area 0.38 m²/g was used as the positive electrode active material, and D2PO was added to the nonaqueous electrolyte in the amount 0.2% by mass.

In Comparative Example 12, iron tris(acetylacetonate) was used as the coupling agent. In Examples 7 to 12, various chemical compounds expressed by Formula (I) below were used as the coupling agent, and in Examples 13 to 17, various silane coupling agents were used. Furthermore, the coupling agents used in Examples 7 to 12 were all chemical compounds containing an alkoxyl group, except for the aluminum tris(acetylacetonate) used in Example 9 and the zirconium tetrakis(acetylacetonate) used in Example 12. The names of the various coupling agents used in Examples 7 to 17 are listed in Table 2:

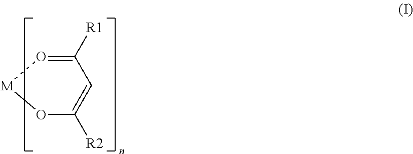

(where M is one item selected from Al, Ti and Zr, each of R1 and R2 is an alkyl group or alkoxy group with 1 to 18 carbon atoms, and n is an integer from 1 to 4).

Also, in Examples 18 to 24 and Comparative Example 13, aluminum bis(ethylacetoacetate) monoacetylacetonate was used as the coupling agent, in amounts varying from 0.003 to 3% by mass for Examples 18 to 24, and in the amount of 4% by mass for Comparative Example 13. The results for Examples 7 to 24 and Comparative Examples 12 and 13 are gathered in Table 2, along with those for Example 3 and Comparative Example 5.

TABLE 2
Positive electrodes: LiCoO₂ Average particle diameter: 9.7 μm
Specific surface area: 0.38 m²/g Di(2-propynyl) oxalate: 0.2% by mass

| | Coupling agent | | | Cycling | |
|---|---|---|---|---|---|
| | | Amount | Initial | characteristics | |
| | | added (% | capacity | 45° C. | 25° C. |
| | Name | by mass) | (mAh) | (%) | (%) |
| Comparative | None | — | 3853 | 80 | 57 |
| Example 5 | | | | | |
| Example 7 | Aluminum ethylacetoacetate | 0.2 | 3854 | 82 | 81 |
| | diisopropylate | | | | |
| Example 8 | Aluminum tris(acetylacetonate) | 0.2 | 3867 | 82 | 80 |
| Example 3 | Aluminum bis(ethylacetoacetate) | 0.2 | 3864 | 84 | 82 |
| | monoacetylacetonate | | | | |
| Example 9 | Aluminum tris(acetylacetonate) | 0.2 | 3863 | 83 | 81 |
| Example 10 | Titanium bis(ethylacetoacetate) | 0.2 | 3861 | 80 | 81 |
| | diisopropoxide | | | | |
| Example 11 | Titanium bis(ethylacetoacetate) | 0.2 | 3859 | 82 | 80 |
| | bis(acetylacetonate) | | | | |
| Example 12 | Zirconium tetrakis(acetylacetonate) | 0.2 | 3862 | 81 | 80 |
| Comparative | Iron tris(acetylacetonate) | 0.2 | 3857 | 80 | 55 |
| Example 12 | | | | | |
| Example 13 | Methyltrimethoxysilane | 1 | 3863 | 81 | 76 |
| Example 14 | Dimethyldimethoxysilane | 1 | 3860 | 80 | 77 |
| Example 15 | Methyltriethoxysilane | 1 | 3856 | 80 | 73 |
| Example 16 | Hexyltrimethoxysilane | 1 | 3867 | 81 | 72 |
| Example 17 | 3-acryloxypropyltrimethoxysilane | 1 | 3856 | 79 | 68 |
| Example 18 | Aluminum bis(ethylacetoacetate) | 0.003 | 3863 | 80 | 69 |
| | monoacetylacetonate | | | | |
| Example 19 | Aluminum bis(ethylacetoacetate) | 0.01 | 3863 | 81 | 73 |
| | monoacetylacetonate | | | | |
| Example 20 | Aluminum bis(ethylacetoacetate) | 0.1 | 3858 | 84 | 80 |
| | monoacetylacetonate | | | | |
| Example 3 | Aluminum bis(ethylacetoacetate) | 0.2 | 3864 | 84 | 82 |
| | monoacetylacetonate | | | | |
| Example 21 | Aluminum bis(ethylacetoacetate) | 0.5 | 3859 | 83 | 81 |
| | monoacetylacetonate | | | | |
| Example 22 | Aluminum bis(ethylacetoacetate) | 1 | 3868 | 81 | 78 |
| | monoacetylacetonate | | | | |
| Example 23 | Aluminum bis(ethylacetoacetate) | 2 | 3861 | 79 | 76 |
| | monoacetylacetonate | | | | |
| Example 24 | Aluminum bis(ethylacetoacetate) | 3 | 3856 | 79 | 75 |
| | monoacetylacetonate | | | | |
| Comparative | Aluminum bis(ethylacetoacetate) | 4 | 3824 | 71 | 73 |
| Example 13 | monoacetylacetonate | | | | |

The following can be seen from the results set forth in Table 2. Where D2PO was added to the nonaqueous electrolyte, the results obtained for Examples 3 and 7 to 12, which used a chemical compound expressed by Formula (I) above as the coupling agent, and for Examples 13 to 17, which used a silane coupling agent, were exceedingly superior to the results for Comparative Example 12, which used iron tris(acetylacetonate) as the coupling agent. It can therefore be seen that it will be preferable to use a chemical compound expressed by Formula (I) above as the coupling agent, or to use a silane coupling agent.

Also, among the results for Examples 3 and 7 to 12, which used a chemical compound expressed by Formula (I) above as the coupling agent, the results for Examples 3 and 7 to 9, in which M was Al, were superior, as regards high-temperature and room-temperature cycling characteristics, to those for Examples 10 and 11, in which M was Ti, and for Example 12, in which M was Zr. It can therefore be seen that when a chemical compound expressed by Formula (I) above is used as the coupling agent, it will be preferable that M be Al.

Also, according to the results for Examples 18 to 24 and Comparative Example 13, in which aluminum bis(ethylacetoacetate) monoacetylacetonate was used as the coupling agent in amounts varying from 0.003 to 4% by mass, amply good results were obtained with addition of the coupling agent in an amount of 0.003% by mass, in contrast to the case where no coupling agent was added (Comparative Example 1), and when the coupling agent was added in the large amount of 4% by mass (Comparative Example 13), the initial capacity fell, and furthermore the high-temperature and room-temperature cycling characteristics fell. It can therefore be seen that in the case where D2PO is added to the nonaqueous electrolyte, it will be preferable that the amount of the chemical compound expressed by Formula (I) above that is added as the coupling agent, or the amount of silane coupling agent that is added, be not less than 0.003% by mass and not more than 3% by mass, relative to the mass of the positive electrode active material.

Examples 25 to 44

In the nonaqueous secondary batteries of Examples 25 to 44, 0.2% by mass of D2PO was added to the nonaqueous electrolyte, and 0.2% by mass of aluminum bis(ethylacetoacetate) monoacetylacetonate was added to the positive electrode mixture layers.

Furthermore, in Examples 25 to 39, the average particle diameter and specific surface area of the LiCoO₂ used as the positive electrode active material were varied across wide ranges, of 3.3 to 16.6 μm and 0.11 to 0.9 m²/g, respectively. Also, for Examples 40 to 44, the measurements were of various different positive electrode active materials other than LiCoO₂. The measurement results for Examples 25 to 44 are gathered in Table 3, along with those for Example 3.

TABLE 3
Aluminum bis(ethylacetoacetate) monoacetylacetonate: 0.2% by mass
Di(2-propynyl) oxalate: 0.2% by mass

| | Positive electrode physical properties | | | | Cycling | |
|---|---|---|---|---|---|---|
| | | Average | Specific | Initial | characteristics | |
| | Positive electrode | particle | surface area | capacity | 45° C. | 25° C. |
| | active material | diameter (μm) | (m²/g) | (mAh) | (%) | (%) |
| Example 25 | LiCoO₂ | 3.3 | 0.85 | 3853 | 76 | 75 |
| Example 26 | LiCoO₂ | 3.5 | 0.63 | 3857 | 75 | 75 |
| Example 27 | LiCoO₂ | 4.5 | 0.55 | 3854 | 80 | 79 |
| Example 28 | LiCoO₂ | 4.6 | 0.72 | 3855 | 82 | 79 |
| Example 29 | LiCoO₂ | 5.2 | 0.9 | 3860 | 76 | 80 |
| Example 30 | LiCoO₂ | 5.5 | 0.8 | 3851 | 80 | 80 |
| Example 31 | LiCoO₂ | 5.7 | 0.67 | 3857 | 81 | 78 |
| Example 32 | LiCoO₂ | 6.1 | 0.49 | 3857 | 82 | 77 |
| Example 3 | LiCoO₂ | 9.7 | 0.38 | 3864 | 84 | 82 |
| Example 33 | LiCoO₂ | 14.3 | 0.11 | 3852 | 75 | 71 |
| Example 34 | LiCoO₂ | 13.1 | 0.25 | 3850 | 80 | 77 |
| Example 35 | LiCoO₂ | 14.6 | 0.22 | 3855 | 79 | 79 |
| Example 36 | LiCoO₂ | 15.2 | 0.18 | 3861 | 82 | 79 |
| Example 37 | LiCoO₂ | 15.5 | 0.13 | 3852 | 81 | 79 |
| Example 38 | LiCoO₂ | 16.4 | 0.16 | 3855 | 75 | 79 |
| Example 39 | LiCoO₂ | 16.6 | 0.12 | 3850 | 75 | 69 |
| Example 40 | LiMn_{1/3}Ni_{1/3}Co_{1/3}O₂ | 10.3 | 0.49 | 3857 | 79 | 76 |
| Example 41 | LiMn₂O₄ | 12.7 | 0.58 | 3862 | 78 | 79 |
| Example 42 | LiNiO₂ | 10.8 | 0.32 | 3863 | 80 | 76 |
| Example 43 | LiNi_{0.85}Co_{0.15}O₂ | 10.2 | 0.31 | 3852 | 82 | 78 |
| Example 44 | LiCo_{0.99}Al_{0.01}O₂ | 9.3 | 0.44 | 3857 | 81 | 77 |

The following can be seen from the results set forth in Table 3. For Examples 27, 28, 30 to 32 and 34 to 37, in which LiCoO₂ with average particle diameter and specific surface area ranging from 4.5 to 15.5 μm and from 0.13 to 0.80 m²/g, respectively, was used as the positive electrode active material, the results for both the high-temperature cycling characteristic, at 79 to 84%, and the room-temperature cycling characteristic, at 77 to 82%, were good.

Also, for Examples 25, 26, 29, 33, 38 and 39, in which LiCoO₂ with average particle diameter under 4.5 μm or exceeding 15.5 μm, and specific surface area under 0.13 m²/g or exceeding 0.80 m²/g, was used as the positive electrode active material, the results for the high-temperature cycling characteristic were 75 to 76% and for the room temperature cycling characteristic 69 to 75%.

From the above results, it will be seen that particularly superior high-temperature and room-temperature cycling characteristics are obtained when the average particle diameter of the positive electrode active material is 4.5 to 15.5 μm and its specific surface area is 0.13 to 0.80 m²/g.

There now follows a discussion of the measurement results for Examples 40 to 44. These represent the results of the cases where LiMn_{1/3}Ni_{1/3}Co_{1/3}O₂, LiMn₂O₄, LiNiO₂, LiNi_{0.85}Co_{0.15}O₂, and LiCo_{0.99}Al_{0.01}O₂ were used as the positive electrode active material, in Examples 40 to 44 respectively. However, in all of Examples 40 to 44, the average particle diameter of the positive electrode active material was inside the range 9.3 to 12.7 μm and its specific surface area inside the range 0.31 to 0.58 m²/g.

According to the results set forth in Table 3, when any of LiMm_{1/3}Ni_{1/3}Co_{1/3}O₂, LiMn₂O₄, LiNiO₂, LiNi_{0.85}Co_{0.15}O₂ and LiCo_{0.99}Al_{0.01}O₂ is used as the positive electrode active material, as good results are obtained, provided that D2PO and a coupling agent are added (which is the case in Examples 40 to 44), as in the case where LiCoO₂ is used as the positive electrode active material. Thus, the result of this discussion of the use of LiCoO₂ as positive electrode active material is that it is evident that it can be applied equally well as can be the positive electrode active materials that are normally employed in nonaqueous secondary batteries.

What is claimed is:

1. A nonaqueous secondary battery comprising:
a positive electrode plate on which is formed a positive electrode mixture layer that contains a lithium complex oxide as positive electrode active material;
a negative electrode plate;
a separator; and
nonaqueous electrolyte,
the nonaqueous electrolyte containing di(2-propynyl) oxalate in a proportion of not less than 0.05% and not more than 3% by mass relative to the total mass of the nonaqueous electrolyte, and
the positive electrode mixture layer containing a silane coupling agent, or one or more coupling agents expressed by Formula (I) below, in a proportion of not less than 0.003% and not more than 3% by mass relative to the mass of the positive electrode active material: 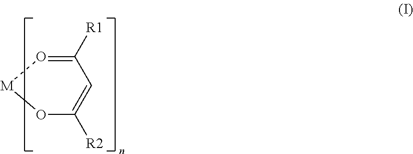
(where M is one item selected from Al, Ti and Zr, each of R1 and R2 is an alkyl group or alkoxy group with 1 to 18 carbon atoms, and n is an integer from 1 to 4).

2. The nonaqueous secondary battery according to claim 1, wherein the positive electrode active material has average particle diameter 4.5 to 15.5 μm and specific surface area 0.13 to 0.80 m²/g.

3. The nonaqueous secondary battery according to claim 1, wherein the di(2-propynyl) oxalate content is not less than 0.1% and not more than 0.5% by mass relative to the total mass of the nonaqueous electrolyte.

4. The nonaqueous secondary battery according to claim 1, wherein the silane coupling agent, one or more coupling agents expressed by Formula (I) below is contained in the positive electrode mixture layer in a proportion of not less than 0.1% and not more than 0.5% by mass relative to the mass of the positive electrode active material: 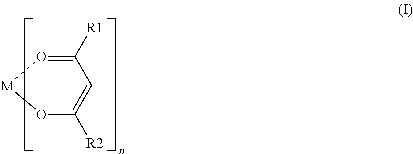
(where M is one item selected from Al, Ti and Zr, each of R1 and R2 is an alkyl group or alkoxy group with 1 to 18 carbon atoms, and n is an integer from 1 to 4).

5. The nonaqueous secondary battery according to claim 1, wherein the positive electrode mixture layer contains the coupling agent expressed by Formula (I) below, and M is Al: 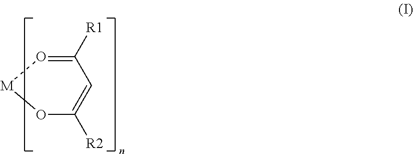
(where each of R1 and R2 is an alkyl group or alkoxy group with 1 to 18 carbon atoms, and n is an integer from 1 to 4).

6. The nonaqueous secondary battery according to claim 1, wherein the coupling agent is one or more items selected from the group consisting of: aluminum bis(ethylacetoacetate) monoacetylacetonate; aluminum ethylacetoacetate diisopropylate; aluminum tris(ethylacetoacetate); aluminum tris(acetylacetonate); titanium bis(ethylacetoacetate) diisopropoxide; titanium bis(ethylacetoacetate) bis(acetylacetonate); zirconium tetrakis(acetylacetonate); methyltrimethoxysilane; dimethylmethoxysilane; methyltriethoxysilane; hexyltrimethoxysilane; and 3-acryloxypropyltrimethoxysilane.

7. The nonaqueous secondary battery according to claim 1, wherein the coupling agent is aluminum bis(ethylacetoacetate) monoacetylacetonate.
